(19) United States
(12) Patent Application Publication
(10) Pub. No.: US 2011/0129079 A1
(43) Pub. Date: Jun. 2, 2011

(54) RINGBACK TONE MONITORING APPARATUS AND METHOD

(76) Inventor: Grant Simonds, Victoria (AU)

(21) Appl. No.: 12/739,570

(22) PCT Filed: Oct. 24, 2008
(86) PCT No.: PCT/AU2008/001581

§ 371 Date: Feb. 15, 2011

(30) Foreign Application Priority Data
Oct. 25, 2007 (AU) 2007905877

(51) Int. Cl. H04M 3/42

(52) U.S. Cl. 379/207.16

(57) ABSTRACT

A method for detecting the presence of a ringback tone in a ringing tone comprises comparing the ringing tone to a benchmark tone so as to detect the presence of a ringback tone. Based on the comparison, a notification is provided as to whether a ringback tone is present.

### FIELD OF THE INVENTION

The present invention relates to an apparatus and method for monitoring ringback tones provided to telephone users.

### BACKGROUND OF THE INVENTION

Ringing tones are audible tones that a calling party hears after dialling a number of a callee (hereafter “called party”) and prior to the called party answering the call. Ringing tones are generated by a telephone exchange, PABX or other connected equipment and provide the calling party with assurance that a ringing signal is being sent to the called party.

Conventionally, ringing tones include a series of beeps which roughly replicate the sound of a phone ringing somewhere in the distance. However, in recent times telephone companies have gained the ability to play other audible tones such as sound effects, music, voice messages (e.g. advertisements), and the like. Such tones may be referred to as personalised ringback tones, or coloured ringback tones.

The ringback tone service not only meets the service individualization requirements of telephone subscribers, but may also be used as an effective marketing tool for businesses. For example, businesses may pay a network operator a fee to play a ringback tone incorporating an advertising message to selected calling parties. Clearly, providing such a service may significantly improve the ringtone service provider's average revenue per user (ARPU) figures. As subscribers and business alike are charged for the personalised ringtone service, there is a need to ensure that the services are functional and of sufficient quality at all times.

### SUMMARY OF THE INVENTION

In accordance with a first aspect, the present invention provides a method for detecting the presence of a ringback tone in a ringing tone comprising the steps of comparing the ringing tone to a benchmark tone so as to detect the presence of a ringback tone, and based on the comparison, providing notification as to whether a ringback tone is present.

In the context of the specification, the term “ringback tone” is used to define any form of audible announcement, song, message or the like which may be used in place of, or to supplement, a standard audible ringing tone provided to a calling party whilst waiting for a call to be answered. For example, the ringback tone may be a short advertising message which is played to the user in place of the standard dial tone, or may be a few bars of a song.

Furthermore, the term “benchmark tone” will be understood to encompass any form of tone that can be used as part of a process to reliably detect the presence and/or quality of a ringback tone. In one embodiment, the benchmark tone may be an original version (i.e. unmodified or unaltered) of the ringback tone. In other words the benchmark tone may be exemplary of how the ringback tone should sound to the caller.

Embodiments of the present invention may advantageously allow for continuous monitoring of a personalised ringback tone service and provide immediate notification if a ringback tone fails to play.

In an embodiment, the method comprises the further step of dialling a ringback tone server to receive the ringing tone.

In an embodiment, the method comprises the further step of filtering out a ringing beep included in the ringing tone prior to performing the comparison.

In an embodiment, where a ringback tone is detected, the method comprises a further step of assessing a quality of the ringback tone. In an embodiment the method comprises performing a spectral analysis of the ringback tone and benchmark tone to assess the quality. In such an embodiment not only can tone failure be detected, but in addition, notification may be provided if a ringback tone is of insufficient quality.

In an embodiment, the quality is determined by performing a frequency domain analysis to assess the total harmonic distortion between the ringback tone and benchmark tone. The total harmonic distortion may be expressed in terms of frequency and/or power.

In an embodiment, the ringback tone and benchmark tone are encoded digital audio signals.

In an embodiment the method comprises the further step of obtaining the benchmark tone from a server associated with a provider of the ringback tone.

In accordance with a second aspect of the present invention there is provided a method for detecting the quality of a ringback tone in a ringing tone comprising the steps of comparing the ringing tone to a benchmark tone so as to determine the quality of the ringback tone and based on the comparison, providing notification as to the quality of the ringback tone.

In an embodiment, the method comprises the further step of dialling a ringback tone service to receive the ringing tone.

In an embodiment, the method comprises the further step of filtering out a ringing beep in the ringing tone prior to performing the comparison.

In an embodiment, the method comprises the further step of performing a spectrum analysis of the ringback tone and benchmark tone to detect the quality.

In an embodiment, the method comprises the further step of performing a frequency domain analysis to determine the total harmonic distortion between the ringback tone and benchmark tone, for providing an indication of the quality.

In an embodiment, the total harmonic distortion is expressed as a score in terms of frequency and/or power.

In an embodiment, the comparison is carried out according to the perceptual evaluation of audio quality (PEAQ)standard.

In an embodiment, the method comprises the further step of providing an alert notification if the score is below a predetermined threshold.

In an embodiment, the method comprises the further step of obtaining the benchmark tone from a remote subscriber system providing the ringback tone.

In accordance with a third aspect, the present invention provides a method for detecting the presence of a multimedia ringback tone in a ringing tone, the method comprising the steps of comparing the ringing tone to a multimedia benchmark tone so as to detect the presence of a multimedia ringback tone and based on the comparison, providing notification as to whether a multimedia ringback tone is present.

In accordance with a fourth aspect of the present invention there is provided a method for detecting the quality of a multimedia ringback tone in a ringing tone comprising the steps of comparing the multimedia ringing tone to a multimedia benchmark tone so as to detect the quality of the multimedia ringback tone and based on the comparison, providing notification as to the quality of the multimedia ringback tone.

In accordance with the third and fourth aspects, multimedia ringback tones, such as audio-visual ringback tones provided during initiation of a video phone call (e.g. on a third generation mobile network), may be inspected to determine a presence and/or quality. In an embodiment, quality of a multimedia ringback tone is determined by comparing the video sequence against a benchmark video sequence to determine a score indicative of the quality of the video sequence. In an embodiment, the comparison utilises the a Perceptual Evaluation of Video Quality (PEVQ) technique. The quality score may subsequently be produced according to the Peak Signal to Noise Ratio PSNR (Y, U, V components), SSIM (Y component), VQM (Y component) or the like.

In accordance with a fifth aspect, the present invention provides a system for detecting a presence of a multimedia ringback tone in a ringing tone, the system comprising a comparator module arranged to compare the ringing tone to a multimedia benchmark tone so as to detect the presence of a multimedia ringback tone and a notification module which, based on the comparison, is arranged to provide notification as to whether a multimedia ringback tone is present.

In accordance with a sixth aspect, the present invention provides a method for detecting the presence of a ringback tone in a ringing tone, the method comprising the steps of performing a frequency domain analysis to determine whether at least one of a power and volume level of a frequency associated with the ringback tone is above a set threshold; and based on the determination, providing notification as to whether a ringback tone is present within the ringing tone.

In accordance with a seventh aspect, the present invention provides a computer program comprising at least one instruction which, when executed by a computing system, causes the computing system to implement the method steps according to the first, second, third, fourth or sixth aspects.

In accordance with an eight aspect, the present invention provides a computer readable medium providing a computer program in accordance with the seventh aspect.

In accordance with a ninth aspect the present invention provides a system for detecting a presence of a ringback tone in a ringing tone, the system comprising: a comparator module arranged to compare the ringing tone to a benchmark tone so as to detect the presence of a ringback tone; and a notification module which, based on the comparison, is arranged to provide notification as to whether a ringback tone is present.

In an embodiment the system comprises a telephony adapter arranged to dial a ringback tone service to receive the ringing tone.

In an embodiment the system further comprises a filter module is arranged to filter out the ringing tone prior to performing the comparison.

In an embodiment the comparator module is arranged to carry out a further step of assessing a quality of the ringback tone.

In an embodiment the comparator module is arranged to perform a spectrum analysis of the ringback tone and benchmark tone to assess the quality.

In an embodiment the comparator module performs a frequency domain analysis to determine the total harmonic distortion between the ringback tone and benchmark tone for providing an indication of the quality.

In an embodiment the total harmonic distortion is output as a score in terms of frequency and/or power.

In an embodiment the notification module outputs an alert notification if the score is below a predetermined threshold.

In an embodiment the ringback tone and benchmark tone are encoded digital audio signals.

In an embodiment the comparator module is arranged to carry out the further step of obtaining the benchmark tone from a subscriber system providing the ringback tone.

In accordance with a tenth aspect the present invention provides a system for detecting the quality of a ringback tone in a ringing tone, the system comprising: a comparator arranged to compare the ringing tone to a benchmark tone so as to determine the quality of a ringback tone; and a notification module which, based on the comparison, is arranged to provide notification as to the quality of the ringback tone.

In accordance with an eleventh aspect the present invention provides a system for detecting the presence of a ringback tone in a ringing tone, the system comprising: a comparator module arranged to perform a frequency domain analysis to determine whether at least one of a power and volume level of a frequency associated with the ringback tone is above a set threshold; and a notification module, which, based on the comparison, is arranged to provide notification as to whether a ringback tone is present within the ringing tone.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of a prior art system for providing ringback tones;

FIG. 2 is a schematic of a system for monitoring a presence and quality of a ringback tone generated by the FIG. 1 system, in accordance with an embodiment of the present invention;

FIG. 3 is a flow chart showing method the steps for monitoring ringback tones using the system of FIG. 2, in accordance with an embodiment of the present invention;

FIG. 3a is a flow chart showing the process flow for comparing a ringback tone to a benchmark tone, in accordance with an embodiment of the present invention.

FIG. 4 is a screen shot showing an output screen generated by the monitoring server of FIG. 2, in accordance with an embodiment of the present invention.

### DETAILED DESCRIPTION OF PREFERRED EMBODIMENTS

In the description which follows an embodiment of the present invention is described in the context of a method and apparatus for monitoring ringback tones over a PSTN network. It will be understood, however, that embodiments are equally suited for monitoring a presence and quality of ringback tones in alternative network configurations including, for example, mobile telephone networks, Private Automatic Branch eXchanges (PABXs), IP Multimedia Subsystems (IMS) and Voice Over IP (VOIP) networks utilising, for example, Session Initiation Protocol (SIP) or H.323 protocol.

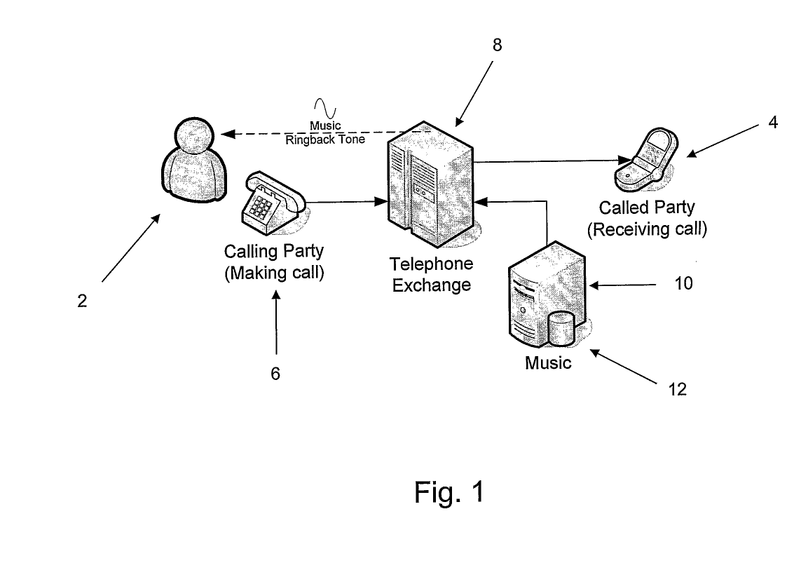

FIG. 1 is a schematic of a prior art system for providing ringback tones in a public switch telephone network (PSTN). In the FIG. 1 drawing, a calling party 2 places a call to a callee (hereafter “called party”) 4 using a telecommunications device 6 in the form of a standard telephone handset. After routing the call to the called party 4, the telephone exchange 8 determines if the called party has subscribed to the ringback tone service. If the called party 2 has subscribed to the ringback service, the telephone exchange 8 queries a ringback tone server 12 to retrieve the appropriate ringback tone for playback to the calling party 2 while the calling party 2 waits for the called party 4 to answer the call. The particular ringback tone used by the tone server 12 may have been previously been selected by the called party 4 by accessing a website provided by the ringback tone server 12.

The quality of the ringback tone played to the calling party may be degraded between the ringback tone server 12 and the called party 4 for a number of reasons. One reason may be due to a mismatch in companding/coding used in the ringback tone server and the telephone exchange. For example, the ringback tone server may use a linear pulse code modulation technique whereas the telephone exchange may use a G.711A-Law technique. Another reason for degradation in ringback tone quality may be due to the ringback tone passing through several telephone exchanges, or transmission links, which utilises different voice compression techniques such as GSM-EFR, AMR-NB, G.711, G.726.

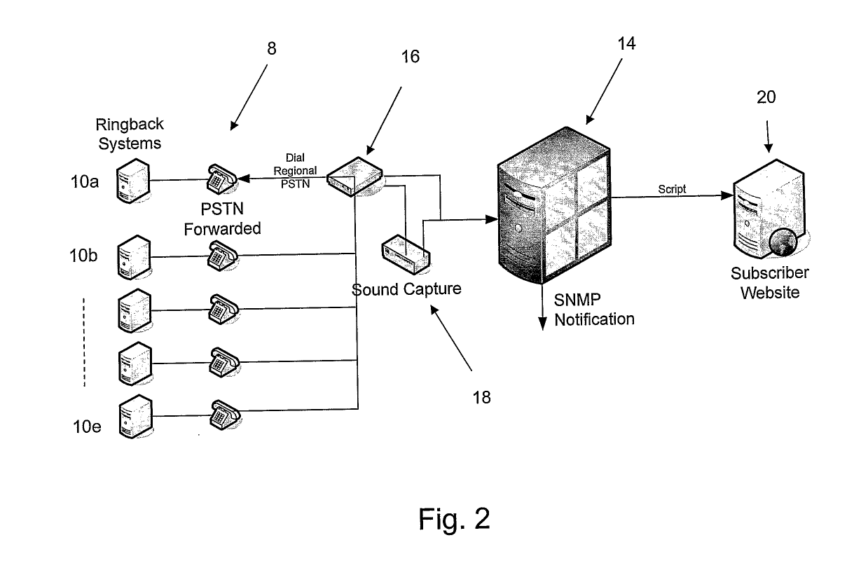

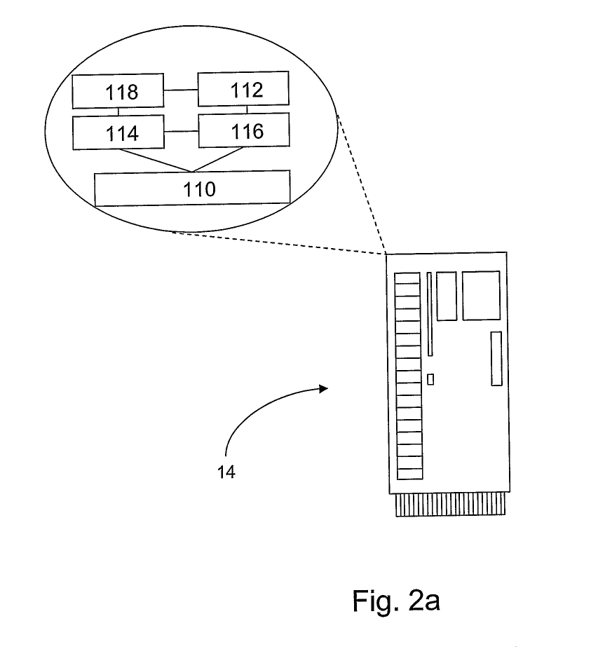

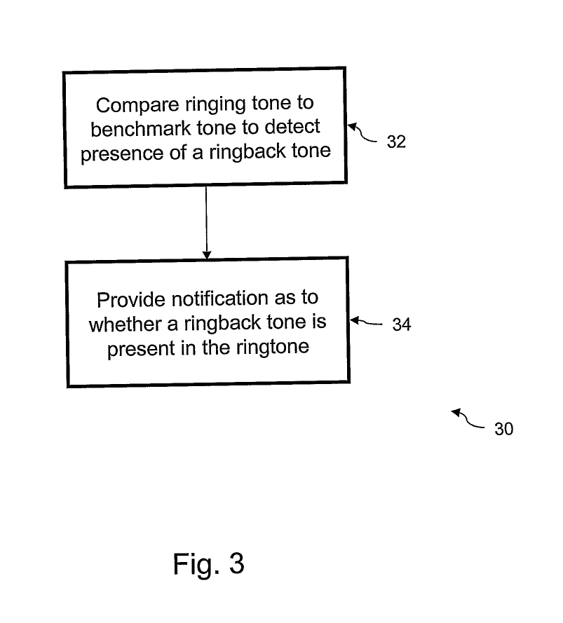

FIG. 2 illustrates an embodiment of a system in accordance with the present invention. The system is operable to detect a presence and quality of a ringback tone in a ringing tone, generated by the system of FIG. 1. Using the FIG. 2 system, the availability and quality of telephone exchange ringback services may be monitored through continued placing of calls to pre-configured telephone numbers. In an embodiment, and with additional reference to FIG. 3, this involves an initial step (step 32) of comparing a ringing tone generated by the tone server 10 with a benchmark tone, to detect the presence of a ringback tone. Based on this comparison, notification may be provided as to whether a ringback tone is present in the ringing tone (step 34).

The individual system elements of the FIG. 2 embodiment include a comparator and notification module 14; telephony adapter 16; plurality of ringback tone servers 10a through 10d; and subscriber website 20.

In this embodiment the comparator and notification module 14 are in the form of a monitoring server 14. The server 14 functions, among other things, to instruct the telephony adapter 16 to place calls to the various ringback tone servers, obtain benchmark ringback tones from the subscriber website 20, communicate with the sound capture apparatus 18 for detecting and determining the quality of a ringback tone output from the ringback servers 10, and provide reporting and notification services. To carry-out this functionality, and with additional reference to FIG. 2a, the monitoring server 14 comprises computer hardware, including a motherboard 110, central processing unit 112, random access memory 114, hard disk 116 and networking hardware 118. In addition to the hardware, the monitoring server 14 includes an operating system (such as the Microsoft Windows™ XP Operating System, which is made by Microsoft Corporation) that resides on the hard disk and which cooperates with the hardware to provide an environment in which the software applications can be executed. In this regard, the hard disk 116 of the server 14 is loaded with a server application which is programmed to carry-out the comparison procedure (i.e. comparison between the ringing tone generated by the ringback system and the benchmark tone obtained from the subscriber website, to determine presence and quality of ringback tones) and provide automatic SNMP alert messages, as will be discussed in more detail in subsequent paragraphs.

The telephony adapter 16 comprises standard hardware and software for placing calls to each of the servers 10a through 10d by way of the PSTN network exchange 8. In alternative embodiment, the adapter 16 may be configured to operate within an ISDN network, mobile network, IP network or other packet, cell or circuit switched network, depending on the network configuration utilised by the calling and called parties.

Lastly, the sound capture apparatus 18 is arranged to capture the ringback tones generated by the various ringback servers 10 in any one of a number of different formats including analogue, PCM, G.711, G.723, G.726, AMR, GSM-EFR or other formats specified by ITU, 3GPP or 3GPP2 for the carriage of audio or voice. In an embodiment, the sound capture device may be a component of the telephony adapter, or the sound capture device may be a separate device interfacing the network to the monitoring server 14.

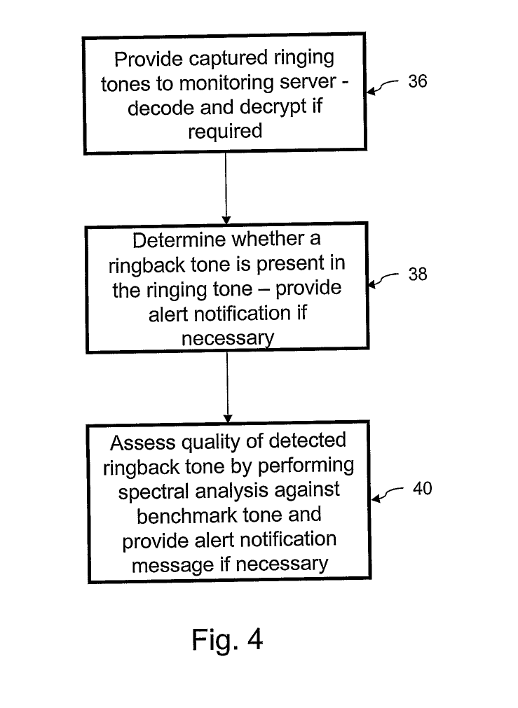

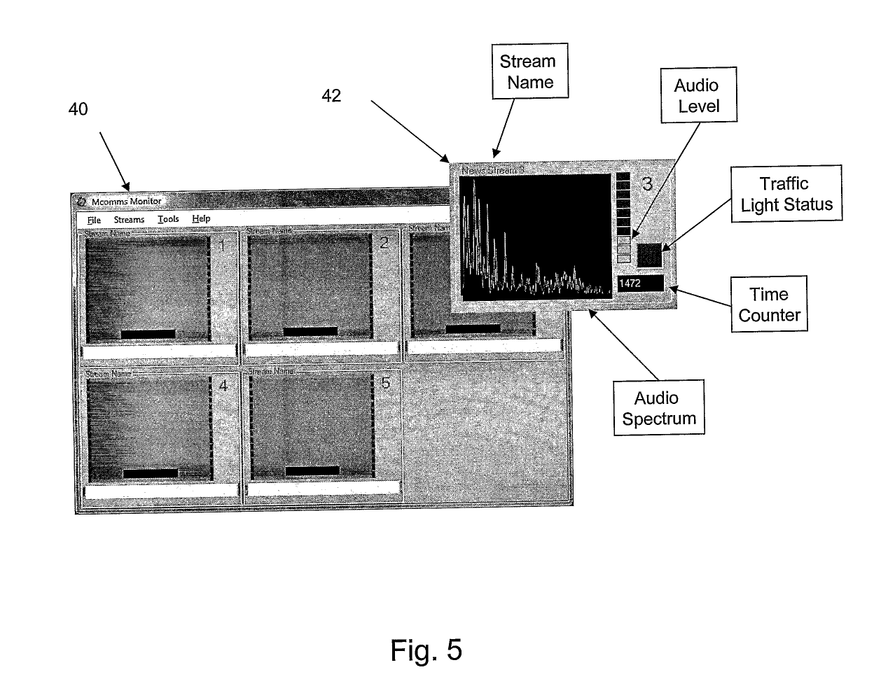

As mentioned, the various system elements operate to detect the presence and quality of a ringback tone generated by the various ringback servers 10a through 10d. A specific example implementation of this process will now be given with reference to FIG. 4.

At step 36, the sound capture apparatus 18 provides the captured ringing tones (i.e. the tones provided to the calling party whilst waiting for the called party to answer) to the monitoring server 14, where they are subsequently decoded and decrypted (if required). This may involve a user initially instructing the telephony adapter to dial the various ringback servers 10 using, for example, pre-programmed numbers to retrieve the ringing tones and then passing the retrieved ringing tones to the sound capture apparatus for capture and storage. The numbers may be manually pre-programmed by an operator of the system or automatically determined from data provided by the end mobile users. The monitoring server 14 subsequently retrieves the associated benchmark tones from the subscriber website 20 (again either by dialling a particular number, or by downloading files which contain the benchmark tone over a network coupling the server 14 to the ringback servers 10). The monitoring server 14 may retrieve the benchmark tones according to a predetermined schedule or responsive to being notified of a scripted change. In the embodiment described herein, the ringing tone and benchmark tone are provided to the sound capture apparatus 18 in one of an encoded Waveform Audio Format (WAV) or VOX format.

At step 38 the monitoring server 14 checks to see whether a ringback tone is present in each of the captured ringing tones. In an embodiment this involves performing a frequency domain analysis to search for a pre-determined frequency (i.e. which falls within the band utilised by the ringback tone) above a threshold volume or power level. If the pre-determined frequency is below the threshold volume or power level, then the server 14 may conclude that the ringback tone is not present, and send an alert message to the relevant tone server 10.

At step 40, the quality of each detected ringback tone is assessed by the monitoring server 14. In an embodiment, software programmed on the monitoring server 14 performs a frequency domain analysis to determine the total harmonic distortion between the ringback tone and associated benchmark tone. A score corresponding to how closely the frequencies and/or power of the two tones are matched is then calculated by the software and displayed on a graphical user interface of the monitoring server 14, for consideration by a staff member. The score may also be stored in a log file for subsequent analysis and/or sent to a performance analysis system.

At step 42 an alert message is provided to the relevant tone server 10 if the ringback tone is of insufficient quality. In an embodiment, the alert message is provided if the output score is not above a predetermined threshold. In an embodiment this notification may be provided utilising the simple network management protocol (SNMP). Again, the determination and notification can be carried out using software programmed on the monitoring server 14.

FIG. 5 is a screen shot of a graphical user interface 40 provided by the monitoring server 14, for monitoring the presence and quality of ringback tones output by the independent tone servers 10a through 10d. Each tone server 10 output is shown in a separate window 42. As can be seen, the window displays the tone server name, together with pertinent audio data calculated by the server 14. A user may simply click on a desired window 42 to play the associated ringback tone through a set of speakers (normally all tones are muted). A “Traffic Light” status indicator provides the user with an instant readily identifiable indication of whether a ringback tone has been detected. In an embodiment, possible indicator states are: Grey=inactive, Blue=starting, Green=audio received normally, orange=audio missing, red=audio lost. As the traffic light changes colour, Windows Events and SNMP traps are automatically generated by the monitoring server 14 to alert staff to a ringback tone failing or recovering. In an embodiment the monitoring server 14 is configured to set a threshold (e.g. in seconds) that an audio or video stream is missing, before raising an alarm or sending an event notification. The score calculated in step 40 may also be displayed in the window 42.

In the embodiments described above, the quality of the ringback tone was determined based on the total harmonic distortion measured between the ringback tone and benchmark tone. However, other comparison techniques may also be used to determine the quality of the ringback tone. In one alternative embodiment, the quality of the ringback tone can be determined according to Perceptual Evaluation of Audio Quality (PEAQ) technique for mean opinion scoring (MOS) of stereo sound accompanying video streams (as specified by the ITU-R recommendation BS.1387, available online at URL http://www.itu.int/rec/R-REC-bs). Alternatively, the quality of the ringback tone can be determined according to Perceptual Evaluation of Speech Quality (PESQ) for MOS scoring of narrow and wide-band telephony voice signals (Listening Quality) according to ITU-T P.862/P.862.1 (narrow-band) and P.862.2 (wide-band). In another embodiment, the quality of the ringback tone can be determined according to Single-sided Speech Quality Measurement according to ITU-T P.563. In yet another embodiment, the quality of the ringback tone can be determined according to Perceptual Speech Quality Measurement (PSQM) technique ITU-T recommendation P.861 for the objective analysis of speech codecs (300 . . . 3400 Hz bandwidth).

In certain network configurations, such as 3G network configurations, a video sequence may additionally be provided in the ringback tone. In other words, a multimedia ringback tone may be provided to the caller. In embodiments, the system of the present invention may also be arranged to detect the quality of such a video sequence. In such a system, the connections between the monitoring server 14 and exchange are digital (e.g. E1, IP, ISDN) and the video sequence generated by the tone servers 10a through 10D are compressed before quality testing.

Like the method for detecting the quality of the ringback tone, the detected video sequence is compared against a benchmark video sequence to determine a score indicative of the quality of the video sequence. In an embodiment, the comparison utilises the “PEVQ—Perceptual Evaluation of Video Quality” technique developed by Opticom (specification sheet available online at URL http://www.opticom.de/download/SpecSheet_PEVQ_{—}06-09-07LR.pdf). The quality score may subsequently be produced according to the Peak Signal to Noise Ratio PSNR (Y, U, V components), SSIM (Y component), VQM (Y component) or the like. It will be understood, however, that the comparison technique described above is non-limiting and other suitable video comparison techniques could equally be used for determining the quality of the video sequence. It will be understood that the various other reporting and notification steps may be carried out in accordance with the same approach outlined above with respect to non multimedia ringback tones.

In each of the above described embodiments, a website provided by the ringback tone server was utilised to select the particular ringback tone for playback to the calling parties. However, in alternative embodiments the ringback tone to be played to calling parties may be selected by sending a message, such as a short message (SMS), multimedia message (MMS), unstructured supplementary service data (USSD) message or the like, to the tone server 12 specifying the desired ringback tone.

A reference herein to a prior art document is not an admission that the document forms part of the common general knowledge in the art in Australia.

1. A method for detecting the presence of a ringback tone in a ringing tone, the method comprising the steps of:
comparing the ringing tone to an exemplary ringback tone so as to detect the presence of a ringback tone in the ringing tone; and
based on the comparison, providing notification as to whether the ringback tone is present.

2. The method of claim 1, comprising the further step of dialling a ringback tone service to receive the ringing tone.

3. The method of claim 1, comprising performing the further step of filtering out a ringing beep in the ringing tone prior to performing the comparison.

4. The method of claim 1, comprising carrying out a further step of assessing a quality of the ringback tone.

5. The method of claim 4, comprising performing a spectrum analysis of the ringback tone and exemplary ringback tone to assess the quality.

6. The method of claim 5, comprising the further step of performing a frequency domain analysis to determine the total harmonic distortion between the ringback tone and exemplary ringback tone, for providing an indication of the quality.

7. The method of claim 6, wherein the total harmonic distortion is expressed as a score in terms of frequency and/or power.

8. The method of claim 1, wherein the comparison is carried out according to the Perceptual Evaluation of Audio Quality (PEAQ) standard.

9. The method of claim 7, comprising the further step of proving an alert notification if the score is below a predetermined threshold.

10. The method of claim 4, wherein the ringback tone and exemplary ringback tone are encoded and/or compressed digital audio signals.

11. The method of claim 1, comprising the further step of obtaining the exemplary ringback tone from a remote subscriber system providing the ringback tone.

12.-23. (canceled)

24. A system for detecting a presence of a ringback tone in a ringing tone, the system comprising:
a comparator module arranged to compare the ringing tone to a benchmark tone so as to detect the presence of a ringback tone; and
a notification module which, based on the comparison, is arranged to provide notification as to whether a ringback tone is present.

25. The system of claim 24, comprising a telephony adapter arranged to dial a ringback tone service to receive the ringing tone.

26. The system of claim 24 further comprising a filter module is arranged to filter out the ringing tone prior to performing the comparison.

27. The system claim 24, wherein the comparator module is arranged to carry out a further step of assessing a quality of the ringback tone.

28. The system of claim 27, wherein the comparator module is arranged to perform a spectrum analysis of the ringback tone and benchmark tone to assess the quality.

29. The system of claim 28, whereby the comparator module performs a frequency domain analysis to determine the total harmonic distortion between the ringback tone and benchmark tone for providing an indication of the quality.

30. The system of claim 29, wherein the total harmonic distortion is output as a score in terms of frequency and/or power.

31. The system of claim 30, whereby the notification module outputs an alert notification if the score is below a predetermined threshold.

32. The system of claim 27, wherein the ringback tone and benchmark tone are encoded digital audio signals.

33. The system of claim 24, whereby the comparator module is arranged to carry out the further step of obtaining the benchmark tone from a subscriber system providing the ringback tone.

34. (canceled)

35. A system for detecting the presence of a ringback tone in a ringing tone, the system comprising:
a comparator module arranged to perform a frequency domain analysis to determine whether at least one of a power and volume level of a frequency associated with the ringback tone is above a set threshold; and
a notification module which, based on the comparison, is arranged to provide notification as to whether a ringback tone is present within the ringing tone.

36. A method for detecting the presence of a multimedia ringback tone in a ringing tone, the method comprising the steps of:
comparing the ringing tone to a multimedia benchmark tone so as to detect the presence of a multimedia ringback tone; and
based on the comparison, providing notification as to whether a multimedia ringback tone is present.

37. The method of claim 36, comprising the further step of dialling a multimedia ringback tone service to receive the ringing tone.

38. The method of claim 36, performing the further step of filtering out a ringing beep in the ringing tone prior to performing the comparison.

39. The method of claim 36, comprising carrying out a further step of assessing a quality of the multimedia ringback tone.

40. The method of claim 36, comprising performing a spectrum analysis of the multimedia ringback tone and multimedia benchmark tone to assess the quality.

41. The method of claim 40, wherein a perceptual evaluation of quality assessment is carried out to determine quality, the assessment being expressed as a score.

42. The method in accordance of claim 41, comprising the further step of proving an alert notification if the score is below a predetermined threshold.

43. A system for detecting the quality of a multimedia ringback tone in a ringing tone, the system comprising:
a comparator module arranged to compare the ringing tone to a multimedia benchmark tone so as to detect the presence of a multimedia ringback tone;
a notification module which, based on the comparison, is arranged to provide notification as to whether a multimedia ringback tone is present.

44. The system of claim 43, wherein the comparator module utilises a perceptual evaluation of video quality technique to make the determination.

45. A computer program product comprising at least one instruction which, when executed by a computing system, causes the computing system to implement the method steps of claim 1.

46. (canceled)
